(19) United States
(12) Patent Application Publication
(10) Pub. No.: US 2023/0202604 A1
(43) Pub. Date: Jun. 29, 2023

(54) SADDLED VEHICLE

(71) Applicant: Honda Motor Co., Ltd., Tokyo (JP)

(72) Inventors: Shimpei SHIKANAI, Tokyo (JP); Junpei AKIYAMA, Tokyo (JP); Kyohei KAWAI, Tokyo (JP)

(73) Assignee: Honda Motor Co., Ltd., Tokyo (JP)

(21) Appl. No.: 17/966,216

(22) Filed: Oct. 14, 2022

(30) Foreign Application Priority Data
Dec. 28, 2021 (JP) 2021-215085

(51) Int. Cl. B62J 27/30; B62K 11/04; B62K 19/30

(52) U.S. Cl. CPC B62J 27/30; B62K 11/04; B62K 19/30

(57) ABSTRACT

To provide a saddled vehicle with excellent maintainability despite auxiliary lamps being mounted on a guard member.

The saddled vehicle includes a front pipe which has its middle portion held on a vehicle body frame and has its both ends held on side pipes, and connection members connecting between the front pipe and the side pipes. The connection members are each provided across the front pipe and corresponding one of the side pipes and include a front pipe-side fixing part and aside pipe-side fixing part. An auxiliary lamp is held via a lamp stay which is held across the front pipe-side fixing part and the side pipe-side fixing part.

### BACKGROUND

### 1. Technical Field

The present invention relates to a saddled vehicle, particularly to a saddled vehicle that has auxiliary lamps mounted on a pipe-like guard member that protects the front of the vehicle body.

### 2. Description of the Background

A conventionally known saddled vehicle has auxiliary lamps such as foglamps mounted on a pipe-like guard member that protects the front of the vehicle body.

Patent Literature 1 discloses a saddled vehicle that includes a guard member having a front pipe and a right and left pair of side pipes, and has auxiliary lamps mounted on the side pipes.

### CITATION LIST

### Patent Literature

Patent Literature 1: JP 6837465 B

### BRIEF SUMMARY

In Patent Literature 1, the auxiliary lamps are mounted on the side pipes. Therefore, when the side pipes are removed from the vehicle body in maintenance or the like, the auxiliary lamps wired to the vehicle body must be removed from the side pipes. Furthermore, when the side pipes are mounted again, it becomes necessary to mount and aim the auxiliary lamps on the side pipes. Thus, Patent Literature 1 is disadvantageous in maintainability.

An object of the present invention is to solve the problem, and to provide a saddled vehicle with excellent maintainability despite auxiliary lamps being mounted on a guard member.

In order to achieve the object, a first aspect of the present invention provides a saddled vehicle (1) including: a vehicle body frame (F); a guard member (80) fixed on the vehicle body frame (F) for protecting the saddled vehicle (1), the guard member (80) including a front pipe (81) and a right and left pair of side pipes (82); and an auxiliary lamp (27) held on the guard member (80). The front pipe (81) has its middle portion held on the vehicle body frame (F) and its both ends held on the side pipes (82). The saddled vehicle (1) further includes connection members (60, 160) that connect between the front pipe (81) and the side pipes (82). The connection members (60, 160) are each provided across the front pipe (81) and corresponding one of the side pipes (82) and include a front pipe-side fixing part (63, 163) and a side pipe-side fixing part (64, 164). The auxiliary lamp (27) is held via a lamp stay (70) that is held across the front pipe-side fixing part (63, 163) and the side pipe-side fixing part (64, 164).

In a second aspect, the front pipe (81) and the side pipes (82) are hollow. The connection members (60) are each inserted into the front pipe (81) and corresponding one of the side pipes (82). The front pipe (81) and the side pipes (82) are provided with through holes (81a, 82a, 181a, 182a) that are opposed to the front pipe-side fixing part (63, 163) and the side pipe-side fixing part (64, 164). The front pipe (81) and the side pipes (82) are connected to each other by fixing components (72, 172) that pass through the through holes (81a, 82a. 181a, 182a).

In a third aspect, the through holes (81a, 82a, 181a, 182a) are provided at a rear surface of the guard member (80).

In a fourth aspect, the lamp stay (70) includes a lamp holding part (70a) that holds the auxiliary lamp (27), a guard connection part (70b) provided across the front pipe-side fixing part (63) and the side pipe-side fixing part (64), and a base part (70c) that connects between the lamp holding part (70a) and the guard connection part (70b). The auxiliary lamp (27) is disposed inner than the guard member (80).

In a fifth aspect, the base part (70c) extends rearward along an inclination of the side pipes (82).

In a sixth aspect, the front pipe (81) and the side pipes (82) each include a seat part (71, 171) that projects rearward.

According to the first aspect, a saddled vehicle (1) includes: a vehicle body frame (F); a guard member (80) fixed on the vehicle body frame (F) for protecting the saddled vehicle (1), the guard member (80) including a front pipe (81), a right and left pair of side pipes (82); and an auxiliary lamp (27) held on the guard member (80). The front pipe (81) has its middle portion held on the vehicle body frame (F) and its both ends held on the side pipes (82). The saddled vehicle (1) further includes connection members (60, 160) that connect between the front pipe (81) and the side pipes (82). The connection members (60, 160) are each provided across the front pipe (81) and corresponding one of the side pipes (82) and include a front pipe-side fixing part (63, 163) and a side pipe-side fixing part (64, 164). The auxiliary lamp (27) is held via a lamp stay (70) that is held across the front pipe-side fixing part (63, 163) and the side pipe-side fixing part (64, 164). This structure allows the side pipes to be removed leaving the auxiliary lamp held on the front pipe. This facilitates the maintenance that is done removing the side pipes and eliminates the necessity of aiming the auxiliary lamp when the side pipes are mounted again. Thus, maintainability improves.

According to the second aspect, the front pipe (81) and the side pipes (82) are hollow. The connection members (60) are each inserted into the front pipe (81) and corresponding one of the side pipes (82). The front pipe (81) and the side pipes (82) are provided with through holes (81a, 82a, 181a, 182a) that are opposed to the front pipe-side fixing part (63, 163) and the side pipe-side fixing part (64, 164). The front pipe (81) and the side pipes (82) are connected to each other by fixing components (72, 172) that pass through the through holes (81a. 82a, 181a, 182a). Thus, the connection members are not exposed to the outside and the fastening portions between the front pipe and the side pipes can have simple shapes. This also improves the fastening strength between the front pipe and the side pipes.

According to the third aspect, the through holes (81a, 82a, 181a, 182a) are provided at a rear surface of the guard member (80). This allows the holder part of the auxiliary lamp to be disposed unobtrusively.

According to the fourth aspect, the lamp stay (70) includes a lamp holding part (70a) that holds the auxiliary lamp (27), a guard connection part (70b) provided across the front pipe-side fixing part (63) and the side pipe-side fixing part ((A), and a base part (70c) that connects between the lamp holding part (70a) and the guard connection part (70b). The auxiliary lamp (27) is disposed inner than the guard member (80). Thus, the auxiliary lamp is positioned to be spaced apart from the guard member.

According to the fifth aspect, the base part (70c) extends rearward along an inclination of the side pipes (82). This allows the auxiliary lamp to hang from the guard member and be suspended in the air. Thus, the lamp stay unobtrusively holds the auxiliary lamp.

According to the sixth aspect, the front pipe (81) and the side pipes (82) each include a seat part (71, 171) that projects rearward. This facilitates positioning the lamp stay. Furthermore, since the holding surface is great in size, the holding position will be maintained with ease despite the side pipes being removed.

### BRIEF DESCRIPTION OF DRAWINGS

FIG. 1 is a left-side view of a motorcycle according to one embodiment of the present invention.

FIG. 2 is a perspective view of the motorcycle as seen from the left front side.

FIG. 3 is a perspective view of a guard member being mounted.

FIG. 4 is a perspective view corresponding to FIG. 3 without the side pipes.

FIG. 5 is an enlarged partial plan view of the motorcycle without a steering handlebar.

FIG. 6 is an enlarged partial left-side view corresponding to FIG. 1.

FIG. 7 is a perspective view of the guard member being mounted on a vehicle body frame.

FIG. 8 is a perspective view of a left lamp stay being mounted.

FIG. 9 is a cross-sectional view of a connection member.

FIG. 10 is a cross-sectional view taken along line X-X in FIG. 9.

FIG. 11 is a cross-sectional view of a connection member according to a second embodiment of the present invention.

FIG. 12 is a cross-sectional view taken along line XII-XII in FIG. 11.

FIG. 13 is a perspective view of passenger footpegs being mounted.

### DETAILED DESCRIPTION

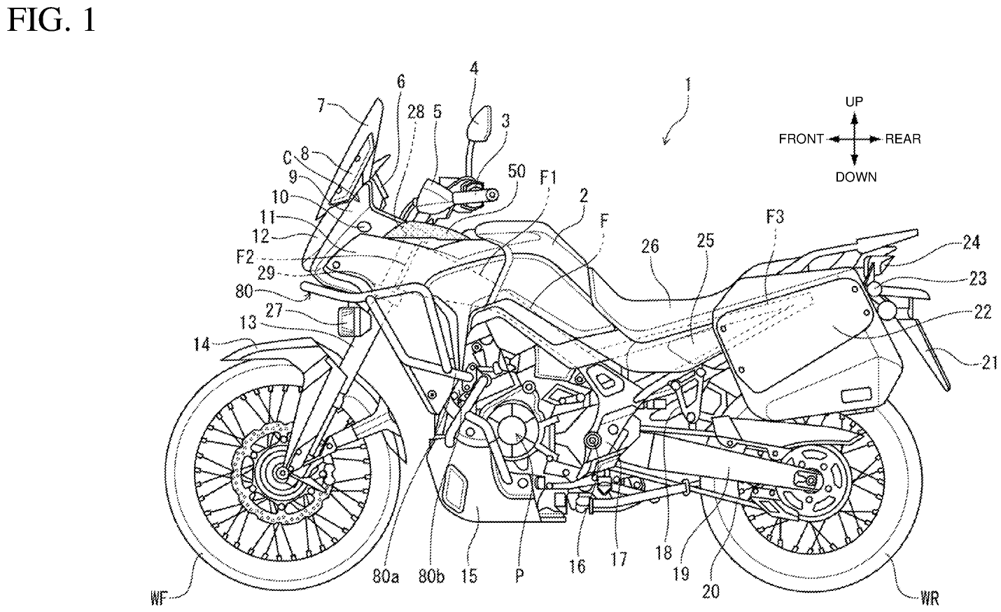

In the following, with reference to the drawings, a detailed description will be given of a preferred embodiment of the present invention. FIG. 1 is a left-side view of a motorcycle 1 according to one embodiment of the present invention. The motorcycle 1 is a saddled vehicle that travels by drive transmitted from a power unit P to a rear wheel WR. At the front end of a main frame F1 that forms a vehicle body frame F, a head pipe F2 is provided to swingably hold a not-shown steering stem.

At the top and bottom of the steering stem, a top bridge 28 and a bottom bridge 29 are respectively fixed to hold a right and left pair of front forks 13. The front forks 13 rotatably hold a front wheel WF by their lower ends.

The main frame F1 has its rear end lower part coupled to a pivot frame 17 that includes a pivot frame 16 that swingably holds a swingarm 19. By its rear end, the swingarm 19 rotatably holds a rear wheel WR as the drive wheel. The pivot frame 17 has its upper part coupled to a rear frame F3 that holds a seat 26 and a rear cowl 25.

A fuel tank 2 is disposed at the upper part of the main frame F1. A power unit P is suspended from the lower part of the main frame F1. The drive of the power unit P is transmitted to the rear wheel WR via a drive chain 20.

A steering handlebar 3 is fixed to the upper part of the top bridge 28. The steering handlebar 3 is equipped with a right and left pair of hand guards 5 and a right and left pair of rearview mirrors 4. A cowl C that covers the front part of the vehicle body is disposed in front of the steering handlebar 3. The cowl C includes a front cowl 9 that covers the outer circumference of a headlamp 12 and holds a windshield screen 7, and a right and left pair of front lateral cowls 11 that covers on the outer sides in the vehicle width direction of the front cowl 9. The windshield screen 7 is equipped with a right and left pair of deflectors 8 that is fastened together with the windshield screen 7. A measuring instrument 6 is disposed behind the windshield screen 7.

A right and left pair of front flasher lamps 10 are mounted on the side part of the front cowl 9. A right and left pair of air guide members 50 as deflectors is disposed behind the front flasher lamps 10. A guard member 80 for protecting the vehicle body is disposed at the front and sides of the cowl C. The guard member 80 formed of a pipe member is equipped with a right and left pair of auxiliary lamps 27. A front fender 14 that covers the front wheel WF from above is mounted on the front forks 13.

A right and left pair of passenger footpegs 18 is attached to the lower part of the rear frame F3. Pannier cases 22 are mounted on the right and left sides of the rear cowl 25. A taillamp device 24, rear flasher lamps 23, and a rear fender 21 are provided at the rear end of the rear cowl 25. A skid plate 15 for protecting the power unit P is disposed at the lower part of the power unit P.

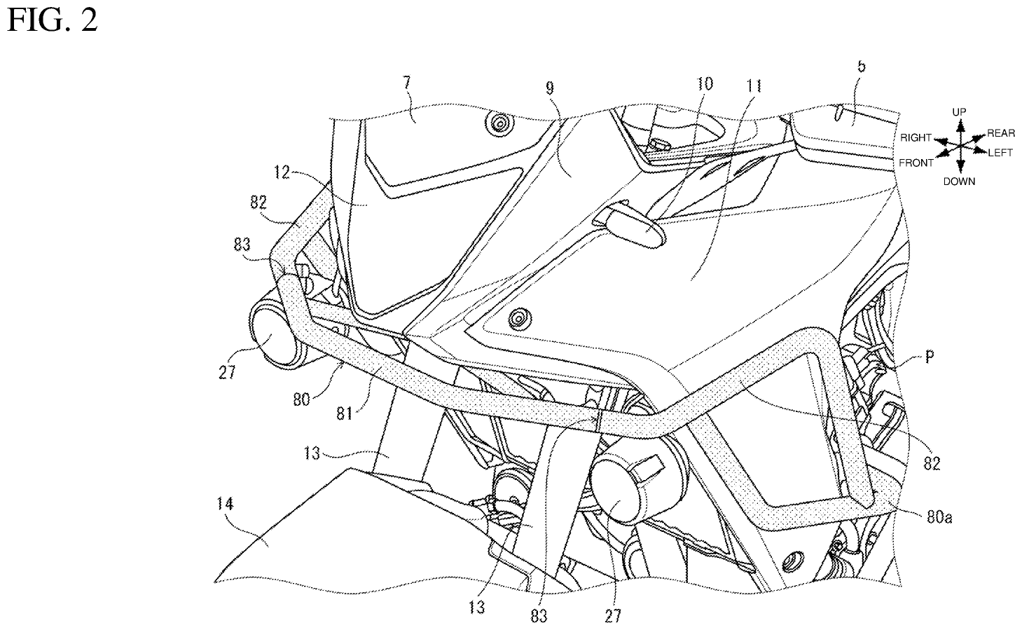

FIG. 2 is a perspective view of a motorcycle 1 as seen from the left front side. A guard member 80 (the shaded part in the drawings) formed of pipe members made of aluminum, iron or the like includes a front pipe 81 positioned at the center in the vehicle width direction and side pipes 82 respectively coupled to the both ends of the front pipe 81. The front pipe 81 has its middle portion fixed to the vehicle body frame F. The side pipes 82 have their rear-end lower-parts 80a fixed to the frame via guard brackets 80b. Between the front pipe 81 and each of the side pipes 82, a joined part 83 as their boundary is formed. The portions for mounting the auxiliary lamps 27 are disposed on the rear side of the front pipe 81 and the side pipes 82.

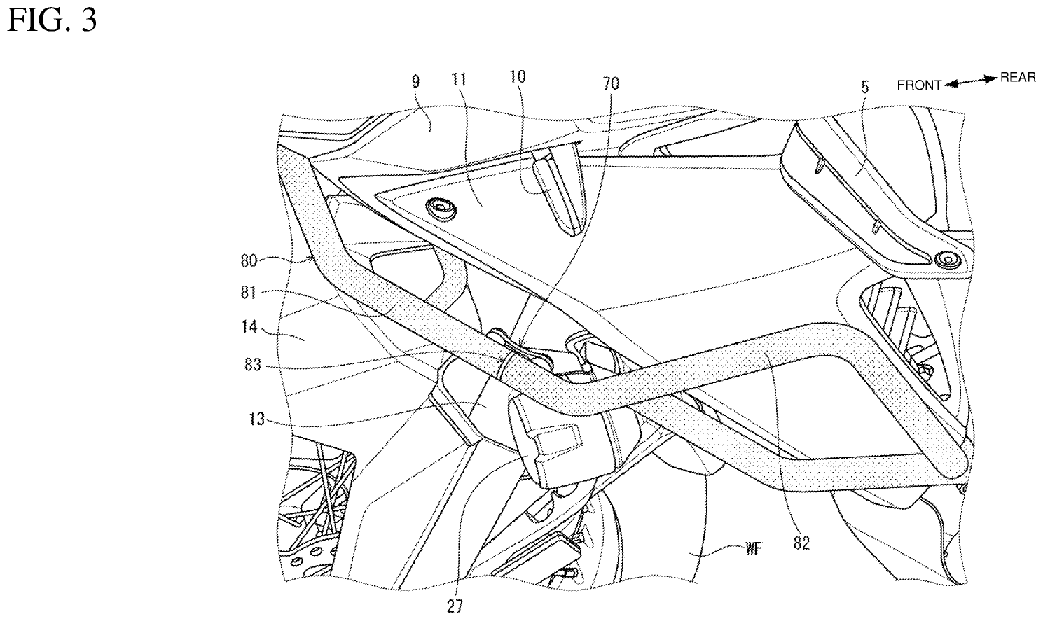

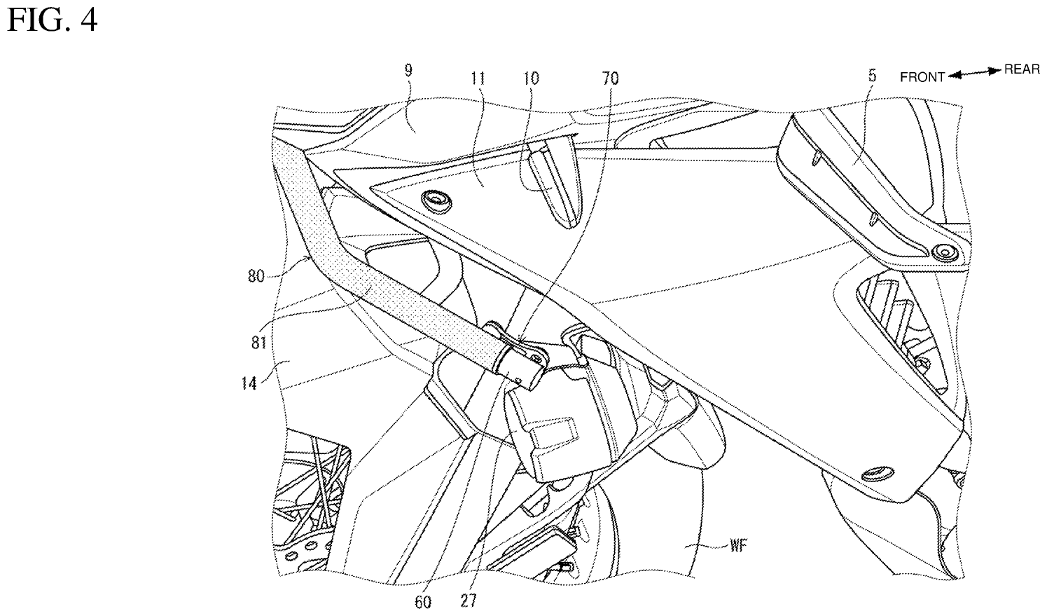

FIG. 3 is a perspective view of the guard member 80 being mounted. FIG. 4 is a perspective view corresponding to FIG. 3 without the side pipes 82. Lamp stays 70 for mounting the auxiliary lamps 27 are fixed to the rear of the joined parts 83. In the present embodiment, each lamp stay 70 is fixed across the front pipe 81 and the corresponding side pipe 82, so that the side pipes 82 can be removed while maintaining the front pipe 81 and the lamp stays 70 fixed to each other. In other words, the side pipes 82 can be removed leaving the auxiliary lamps 27 on the front pipe 81. This facilitates maintenance that is done removing the side pipes 82 and eliminates the necessity of aiming the auxiliary lamps 27 when the side pipes 82 are mounted again. Connection members 60 are each inserted between the front pipe 81 and corresponding one of the side pipes 82.

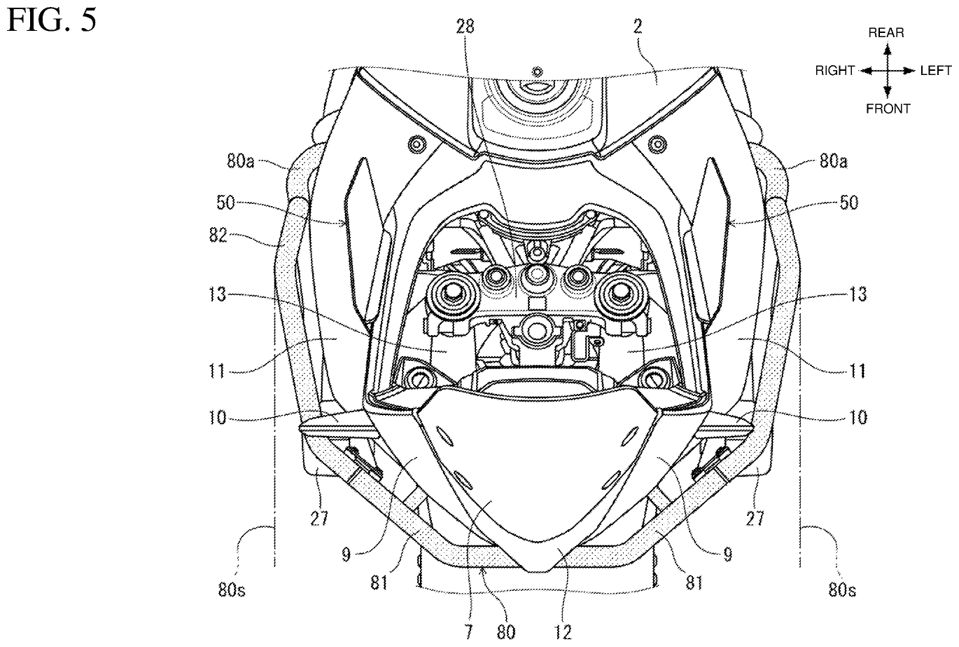

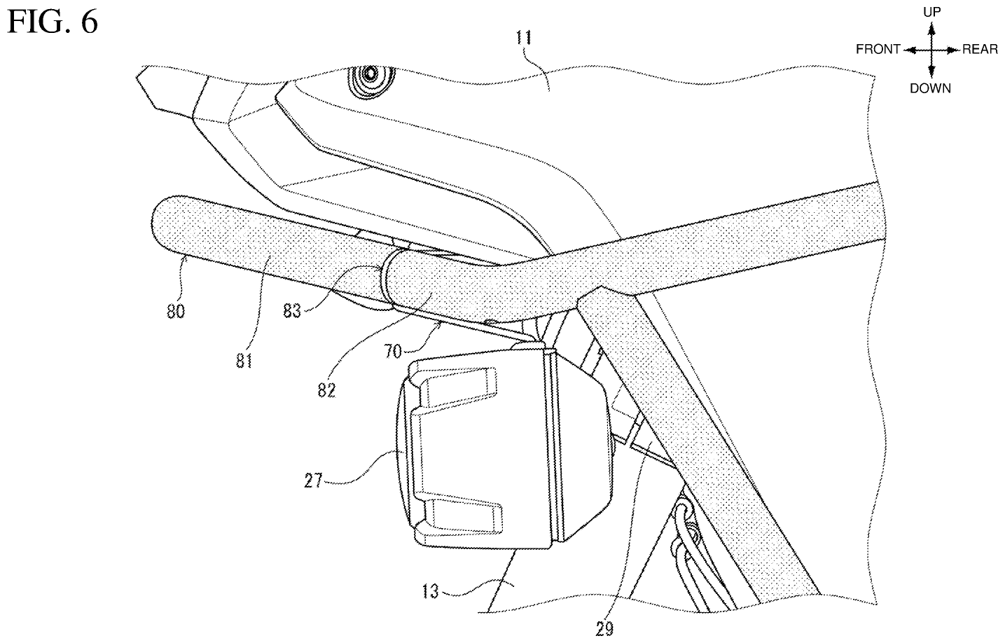

FIG. 5 is an enlarged partial plan view of the motorcycle 1 without the steering handlebar 3. FIG. 6 is an enlarged partial left-side view corresponding to FIG. 1. The auxiliary lamps 27 are fixed and suspended by the lamp stays 70 between the front pipe 81 and the side pipes 82. The front pipe 81 and the side pipes 82 have their frontward portions inclined frontward upward in a side view of the vehicle. The lamp stays 70 extend rearward along this inclination. This allows the auxiliary lamps 27 to hang from the guard member 80 and be suspended in the air. Thus, the lamp stays 70 unobtrusively hold the auxiliary lamps 27. The auxiliary lamps 27 partially overlap with the guard member 80 in a plan view of the vehicle, and are disposed inner than outermost sides 80s of the guard member 80.

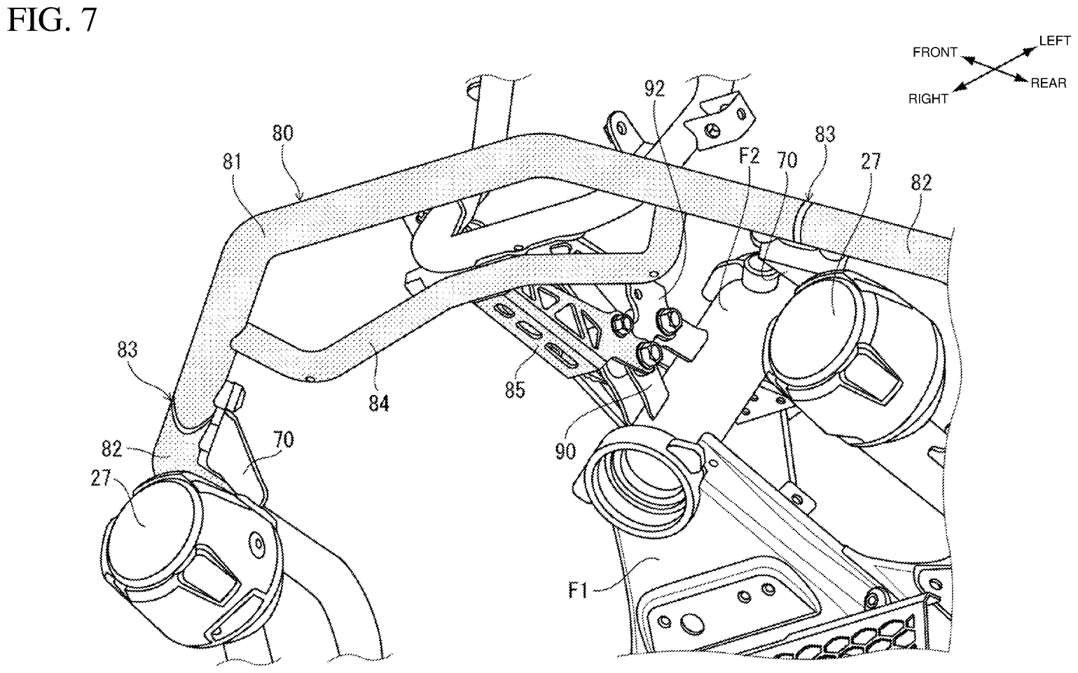

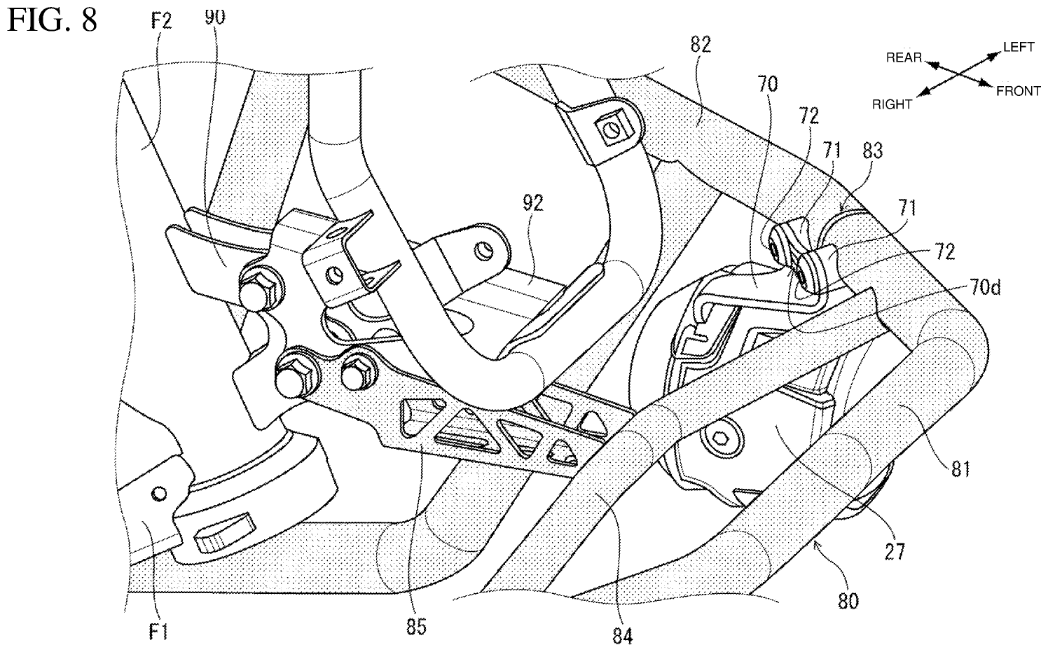

FIG. 7 is a perspective view of the guard member 80 being mounted on the vehicle body frame F. FIG. 8 is a perspective view of the left lamp stay 70 being mounted. The front pipe 81 has its middle portion welded to an auxiliary pipe 84 which enhances the strength of the front pipe 81 and enables it to be mounted on the vehicle body frame F. The auxiliary pipe 84 has its rear welded to a frame stay 85 whose cross section is substantially U-shaped. The head pipe F2 of the vehicle body frame F has its front welded to a holder part 90 formed of two plate-like members. By the frame stay 85 being fixed to the holder part 90, the front pipe 81 is held on the vehicle body frame F. The headlamp stay 92 that holds the headlamp 12 is also fixed to the holder part 90. The frame stay 85 is fixed together with both of the headlamp stay 92 and the holder part 90.

The lamp stays 70 are fixed to the front pipe 81 and the side pipes 82 by fixing components 72 such as bolts. Seat parts 71 each being a substantially cylindrical collar are inserted between the lamp stays 70, and the front pipe 81 and the side pipes 82. One end of each seat part 71 is flat to receive the corresponding lamp stay 70, and the other end of each seat part 71 is arc-like conforming to the outer circumference of the guard member 80. The seat parts 71 facilitate positioning the lamp stays 70. Furthermore, since the seat parts 71 increase the size of the flat holding surfaces, the holding position will be maintained even when the side pipes 82 are removed. Each lamp stay 70 is provided with a laterally elongated weight-reducing hole 70d between two fixing components 72.

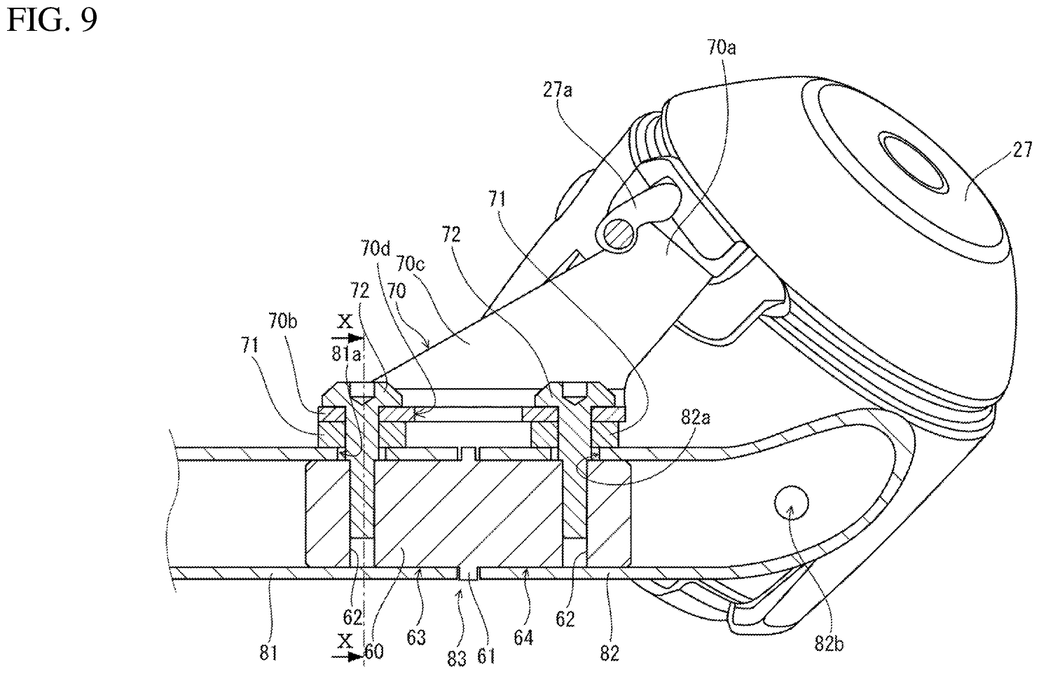

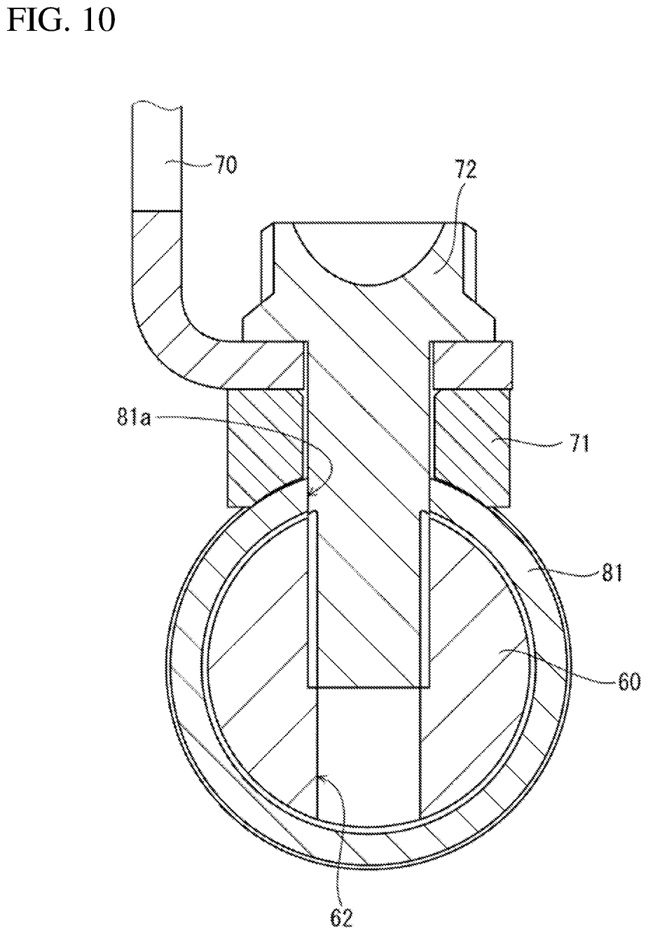

FIG. 9 is a cross-sectional view of the connection member 60 showing its structure. FIG. 10 is a cross-sectional view taken along line X-X in FIG. 9. The connection member 60 includes a front pipe-side fixing part 63 inserted into the front pipe 81, a side pipe-side fixing part 64 inserted into the corresponding side pipe 82, and an increased-diameter part 61 separating the front pipe-side fixing part 63 and the side pipe-side fixing part 64 from each other. The diameter of the front pipe-side fixing part 63 and that of the side pipe-side fixing part 64 are slightly smaller than the diameter of the front pipe 81 and that of the side pipes 82 so that the front pipe-side fixing part 63 and the side pipe-side fixing part 64 loosely fit to the front pipe 81 and the side pipes 82. The increased-diameter part 61 is exposed to the outside and forms the joined part 83, and facilitates positioning in coupling the front pipe 81 and the side pipes 82 to each other.

The connection member 60 is provided with a female screw hole 62 with which the fixing component 72 screws. In coupling the front pipe 81 and the side pipes 82 to each other and fixing the auxiliary lamps 27, firstly, the operator inserts the connection members 60 into the front pipe 81. Having the seat parts 71 inserted between the front pipe 81 and the lamp stays 70, the operator then rotates the connection members 60 to determine the position, and screws the fixing components 72 with the female screw holes 62 as tentative assembly. Next, the operator inserts the connection members 60 into the side pipes 82. Having the seat parts 71 inserted between the side pipes 82 and the lamp stays 70, the operator rotates the side pipes 82 to determine the position, and screws the fixing components 72 with the female screw holes 62 as tentative assembly. Retaining the auxiliary lamps 27 to orient frontward, the operator fastens the fixing components 72 (an aiming mechanism is separately built in each auxiliary lamp 27).

In this manner, since the front pipe 81 and the side pipes 82 are connected to each other by the fixing components 72, the connection members 60 are not exposed to the outside and the fastening portions between the front pipe 81 and the side pipes 82 can have simple shapes. This also improves the coupling strength between the front pipe 81 and the side pipes 82. The contact surfaces when the fixing components 72 are fastened are the pipe's outer circumferential surface and the seat parts 71, and the pipe's inner circumferential surface and the connection members 60, which are fixed by tightening torque (axial tension).

The front pipe 81 and the side pipes 82 are provided with through holes 81a, 82a for the fixing component 72 to pass through. The through holes 81a, 82a are provided at the rear surfaces of the front pipe 81 and the side pipes 82. This structure allows the holder parts of the auxiliary lamps 27 to be disposed unobtrusively and improves the appearance. At the lower surfaces of the side pipes 82, drain holes 82b for draining water entered inside the guard member 80 are formed.

The lamp stays 70 formed of metal plates or the like each include a lamp holding part 70a that holds the corresponding auxiliary lamp 27, a guard connection part 70b provided across the front pipe-side fixing part 63 and the side pipe-side fixing part 64, and a base part 70c that connects between the lamp holding part 70a and the guard connection part 70b. The base part 70 has its width narrowed toward its rear. The auxiliary lamps 27 each connected to a wire 27a are disposed inner than the guard member 80. Thus, the auxiliary lamps 27 are positioned to be spaced apart from the guard member 80. The guard connection part 70b is provided with the laterally elongated weight-reducing hole 70d.

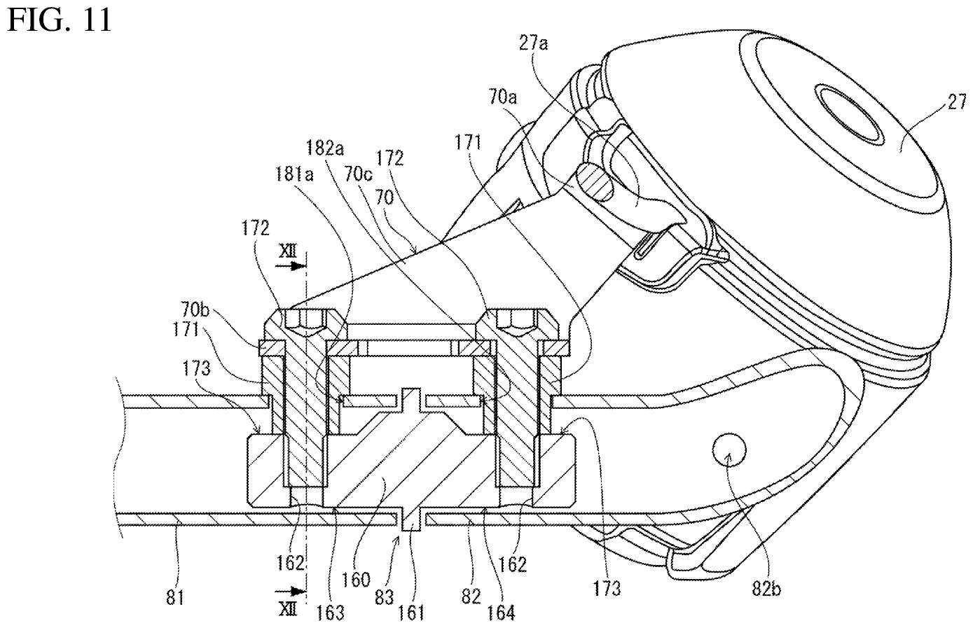

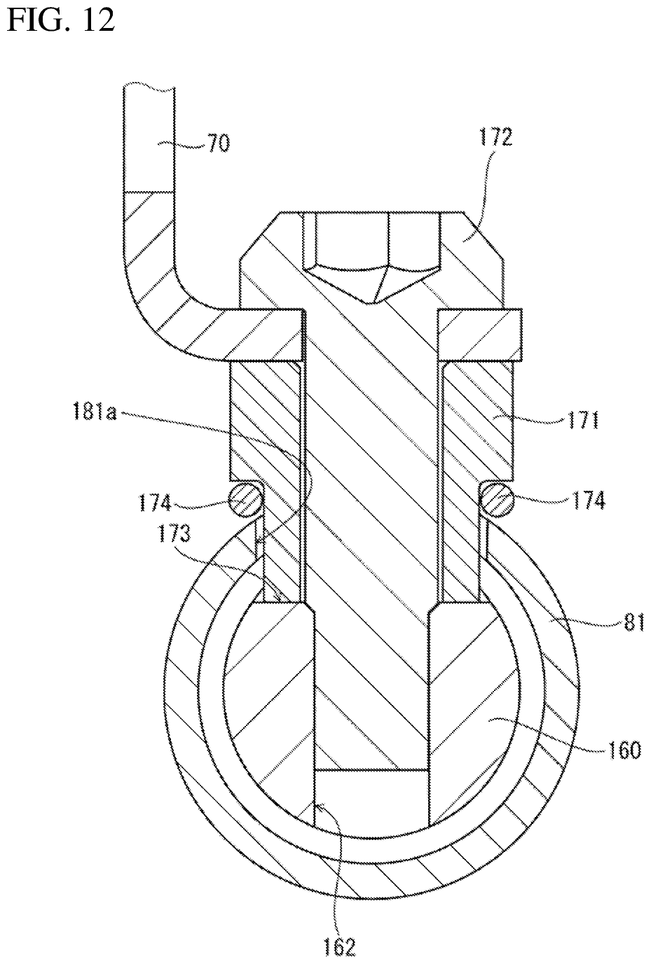

FIG. 11 is a cross-sectional view of a connection member 160 according to a second embodiment of the present invention. FIG. 12 is a cross-sectional view taken along line XII-XII in FIG. 11. The reference characters identical to the first embodiment refer to identical or similar parts. The connection member 160 according to the present embodiment has a diameter small enough to leave a gap from the inner side of the front pipe 81 and that of the corresponding side pipe 82. The connection member 160 includes a front pipe-side fixing part 163 inserted into the front pipe 81, a side pipe-side fixing part 164 inserted into the corresponding side pipe 82, and an increased-diameter part 161 separating them from each other. The connection member 160 is provided with a female screw hole 162 with which a fixing component 172 screws, and a seat surface 173 formed by removing part of the circular section. The increased-diameter part 161 is greater than the outer circumference of the front pipe 81 and that of the corresponding side pipe 82, and exposed to the outside to form the joined part 83. The increased-diameter part 161 is spaced apart from the end of the front pipe 81 and the corresponding side pipe 82. This structure allows the connection member 160 to be mounted while absorbing individual differences in components and function as a shield that hides the inside of the pipes.

In the present embodiment, stepped cylindrical seat parts 171 are welded by beads 174 to the front pipe 81 and the side pipes 82. The seat surface 173 formed at each connection member 160 and the lower end surface of each seat part 171 are in plane-contact with each other. In coupling the front pipe 81 and the side pipes 82 to each other and fixing the auxiliary lamps 27, firstly, the operator inserts the connection members 160 into the front pipe 81, and slightly moves the connection members 160 to determine the position. Then, the operator screws the fixing components 172 with the female screw holes 162 as tentative assembly. Next, the operator inserts the connection members 160 into the side pipes 82, and rotates the side pipes 82 to determine the position. The operator then screws the fixing components 72 with the female screw holes 162 as tentative assembly. While adjusting the optical axis (aiming), the operator fastens the fixing components 172. Thus, the connection members 160 are easily positioned. In addition, the plane-contact structure with great contact surfaces enhances the fastening reliability.

The front pipe 81 and the side pipes 82 are provided with through holes 181a, 182a into which the seat parts 171 are inserted. The through holes 181a, 182a are provided at the rear surfaces of the front pipe 81 and the side pipes 82. This structure allows the holder parts of the auxiliary lamps 27 to be disposed unobtrusively. The front pipe 81 and the side pipes 82 may have a slight gap from the increased-diameter parts 161 as in the drawings, or may be brought into close contact with each other.

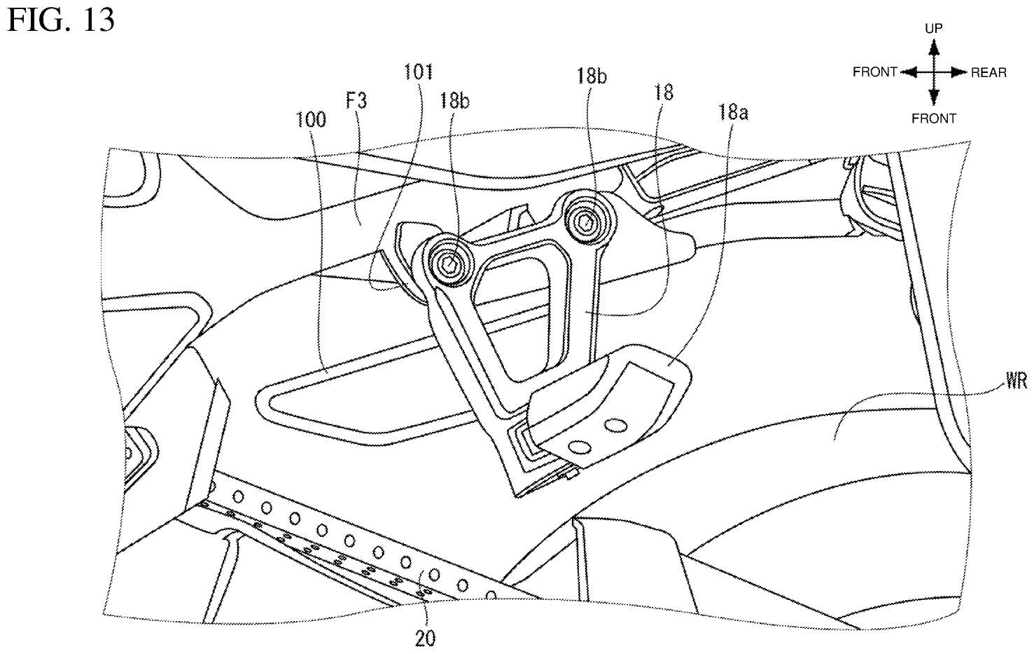

FIG. 13 is a perspective view of the passenger footpeg 18 being mounted. The right and left passenger footpegs 18 mounted by bolts 18b on stays 101 at the lower part of the rear frame F3 each include a folding step part 18a. In the present embodiment, a curved rod-like chain guard 100 is provided on the inner side than the body part supporting the step part 18a. This effectively prevents the access of the passenger's foot to the drive chain 20.

As described above, in the auxiliary lamp mounting structure of the present invention, the front pipe 81 has its middle portion held on vehicle body frame F and has its both sides held on the side pipes 82. The connection members 60, 160 that connect between the front pipe 81 and the side pipes 82 are provided. The connection members 60, 160 are each provided across the front pipe 81 and corresponding one of the side pipes 82 and include the front pipe-side fixing part 63, 163 and the side pipe-side fixing part 64, 164. The auxiliary lamps 27 are each held via the lamp stay 70 that is held across the front pipe-side fixing part 63, 163 and the side pipe-side fixing part 64, 164. This structure allows the side pipes 82 to be removed leaving the auxiliary lamps 27 held on the front pipe 81. This facilitates the maintenance that is done removing the side pipes 82 and eliminates the necessity of aiming the auxiliary lamps 27 when the side pipes 82 are mounted again.

The mode of the motorcycle, the shape or structure of the front pipe or the side pipes, the mode of the auxiliary lamps, the shape or structure of the connection members, the shape or structure of the lamp stays are not specified to the embodiments, and various changes may be made. The auxiliary lamp mounting structure of the present invention is not limited to a motorcycle and is applicable to a saddled three- or four-wheel vehicle.

### REFERENCE SIGNS LIST

1: motorcycle (saddled vehicle)
27: auxiliary lamp
60: connection member
63: front pipe-side fixing part
64: side pipe-side fixing part
70: lamp stay
70a: lamp holding part
70b: guard connection part
70c: base part
71: seat part
72: fixing component
80: guard member
81: front pipe
82: side pipe
81a, 82a: through hole
F: vehicle body frame

What is claimed is:

1. A saddled vehicle comprising:
a vehicle body frame; and
a guard member fixed on the vehicle body frame for protecting the saddled vehicle, the guard member including a front pipe and a right and left pair of side pipes; and
an auxiliary lamp held on the guard member, wherein
the front pipe has its middle portion held on the vehicle body frame and its both ends held on the side pipes, the saddled vehicle further comprising
connection members that connect between the front pipe and the side pipes, wherein
the connection members are each provided across the front pipe and corresponding one of the side pipes and include a front pipe-side fixing part and a side pipe-side fixing part, and
the auxiliary lamp is held via a lamp stay that is held across the front pipe-side fixing part and the side pipe-side fixing part.

2. The saddled vehicle according to claim 1, wherein
the front pipe and the side pipes are hollow,
the connection members are each inserted into the front pipe and corresponding one of the side pipes,
the front pipe and the side pipes are provided with through holes that are opposed to the front pipe-side fixing part and the side pipe-side fixing part, and
the front pipe and the side pipes are connected to each other by fixing components that pass through the through holes.

3. The saddled vehicle according to claim 2, wherein the through holes are provided at a rear surface of the guard member.

4. The saddled vehicle according to claim 2, wherein
the lamp stay includes a lamp holding part that holds the auxiliary lamp, a guard connection part provided across the front pipe-side fixing part and the side pipe-side fixing part, and a base part that connects between the lamp holding part and the guard connection part, and
the auxiliary lamp is disposed inner than the guard member.

5. The saddled vehicle according to claim 4, wherein the base part extends rearward along an inclination of the side pipes.

6. The saddled vehicle according to claim 1, wherein the front pipe and the side pipes each include a seat part that projects rearward.

7. The saddled vehicle according to claim 3, wherein
the lamp stay includes a lamp holding part that holds the auxiliary lamp, a guard connection part provided across the front pipe-side fixing part and the side pipe-side fixing part, and a base part that connects between the lamp holding part and the guard connection part, and
the auxiliary lamp is disposed inner than the guard member.

8. The saddled vehicle according to claim 2, wherein the front pipe and the side pipes each include a seat part that projects rearward.

9. The saddled vehicle according to claim 3, wherein the front pipe and the side pipes each include a seat part that projects rearward.

10. The saddled vehicle according to claim 4, wherein the front pipe and the side pipes each include a seat part that projects rearward.

11. The saddled vehicle according to claim 5, wherein the front pipe and the side pipes each include a seat part that projects rearward.
